(19) United States
(12) Patent Application Publication
(10) Pub. No.: US 2010/0191770 A1
(43) Pub. Date: Jul. 29, 2010

(54) SYSTEMS AND METHODS FOR PROVIDING A VIRTUAL FASHION CLOSET

(75) Inventors: Christine Kim Cho, Cupertino, CA (US); Monica Tran, Hayward, CA (US); Stanley Carl Ng, Los Altos, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/543,288

(22) Filed: Aug. 18, 2009

Related U.S. Application Data
(60) Provisional application No. 61/147,654, filed on Jan. 27, 2009.

(51) Int. Cl. G06F 17/30; G06Q 30/00; G06F 7/00

(52) U.S. Cl. 707/783; 707/E17.029; 707/E17.014

(57) ABSTRACT

This is directed to systems and methods for providing a virtual fashion closet. Fashion items can be added to the Virtual Closet. Outfits may then be created by combining two or more of the fashion items. In some embodiments, the Virtual Closet system can create recommended outfits based on weather, season, or the user's calendar. The Virtual Closet system can allow a vendor to send recommended fashion items that may complete an outfit to a user for potential purchasing. In some embodiments, a social networking Virtual Closet can be provided. The social networking Virtual Closet can allow friends to see each other's Virtual Closets, recommend outfits to one another, recommend fashion items to buy, recommend fashion items to get rid of, recommend outfits to wear at a particular event, share and borrow each other's fashion items, or can otherwise suitably provide a social networking environment through the Virtual Closet.

### CROSS-REFERENCE TO RELATED APPLICATIONS

This application claims the benefit of U.S. Provisional Patent Application No. 61/147,654, filed on Jan. 27, 2009, which is hereby incorporated by reference herein in its entirety.

### FIELD OF THE INVENTION

This relates to systems and methods for providing a virtual fashion closet. In particular, this relates to systems and methods for providing a social networking Virtual Closet.

### BACKGROUND OF THE DISCLOSURE

Everyday, people have various articles of clothing, jewelry, purses, and other accessories that they wear and carry. These items can be stored at home in closets, drawers, shelves, or in other storage facilities. However, at times it may be difficult for a person to keep track of their clothing or easily view what items they own. For example, articles of clothing in a closet may be crowded together in a way that makes it difficult to view them, or the clothing may be stored in drawers or otherwise hidden from sight. As another example, a person may lend their clothing or other items to friends, and then forget who has borrowed these belongings. This may make it difficult for a person to organize or keep track of their clothing and other belongings.

### SUMMARY OF THE DISCLOSURE

Systems and methods for providing a virtual fashion closet are described herein. The Virtual Closet may, for example, be provided through an application that is available on an electronic device. The electronic device can include any suitable device such as, for example, a laptop computer, a desktop computer, a digital media player, a personal e-mail device, a personal data assistant (“PDA”), a cellular telephone, a handheld gaming device, a digital camera, or any other suitable electronic device.

The Virtual Closet can include a catalogue or virtual representation of an actual, physical closet of a user. For example, the Virtual Closet may include images, descriptions, or both of “fashion items” owned by the user. As used herein, the term “fashion item” refers to any article of clothing, accessory, or other suitable item that a person may wear or carry.

In some embodiments, outfits can be created by combining two or more fashion items of a Virtual Closet. For example, an owner of a Virtual Closet can create outfits from the fashion items in the Virtual Closet. As another example, outfits can be created that include fashion items that are not in the Virtual Closet. As one illustration, fashion items that are offered for sale by a third party (e.g., a store or vendor) can be used to build outfits, thus allowing a user to “try out” fashion items prior to buying that fashion item. In some embodiments, a vendor can recommend the user buy a fashion items in order to complete a particular outfit.

In some embodiments, the Virtual Closet can recommend outfits to be worn. For example, the Virtual Closet can recommend outfits based on the weather, based on the day or season, based on events that are scheduled in the user's calendar, or based on any other suitable event. In some embodiments, the Virtual Closet can maintain a history of the fashion items that are worn by a user. The Virtual Closet can identify which fashion items are dirty (e.g., in the laundry) and therefore may be unavailable for wearing.

In some embodiments, a social networking Virtual Closet can be provided. The social networking Virtual Closet can allow friends to see each other's Virtual Closets, recommend outfits to one another, recommend fashion items to buy, recommend fashion items to get rid of, recommend outfits to wear at a particular event, share and borrow each other's fashion items, or can otherwise suitably provide a social networking environment through the Virtual Closet.

### BRIEF DESCRIPTION OF THE DRAWINGS

The above and other features of the invention, its nature and various advantages will be more apparent upon consideration of the following detailed description, taken in conjunction with the accompanying drawings in which:

FIG. 1 is a schematic view of an illustrative electronic device for providing a Virtual Closet system in accordance with some embodiments of the invention;

FIG. 2 is an illustrative interface for displaying fashion items in accordance with some embodiments of the invention;

FIGS. 3A and 3B are illustrative interfaces for providing visual representations of fashion item use in accordance with some embodiments of the invention;

FIGS. 4-5 are illustrative interfaces for providing a social networking Virtual Closet in accordance with some embodiments of the invention;

FIG. 6 is an illustrative interface for providing the borrowing and sharing of fashion items of a Virtual Closet in accordance with some embodiments of the invention;

FIGS. 7A and 7B are illustrative calendars provided by a social networking Virtual closet in accordance with some embodiments of the invention; and

FIGS. 8 and 9 are illustrative processes for providing a social networking Virtual Closet in accordance with some embodiments of the invention.

### DETAILED DESCRIPTION OF THE DISCLOSURE

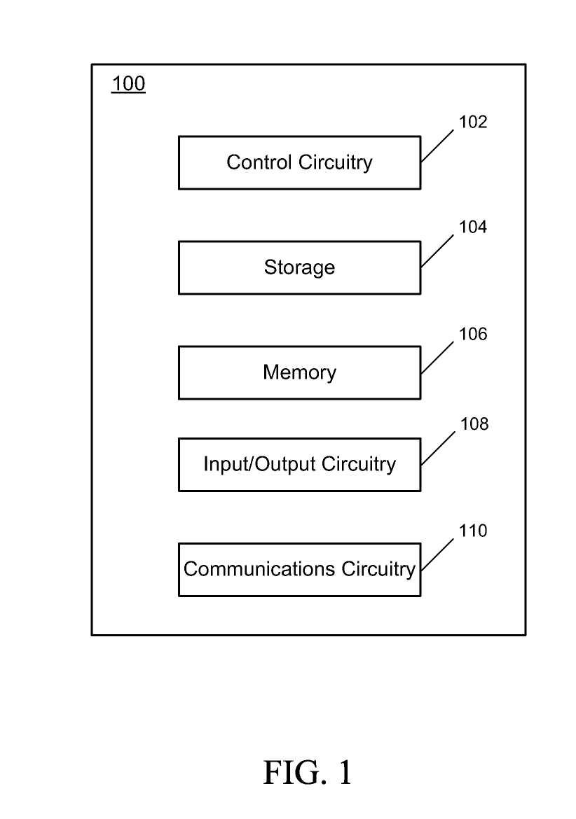

FIG. 1 is a schematic view of an illustrative electronic device for providing a Virtual Closet system in accordance with some embodiments. Electronic device 100 can include control circuitry 102, storage 104, memory 106, input/output (“I/O”) circuitry 108, and communications circuitry 110. In some embodiments, one or more of the components of electronic device 100 can be combined or omitted (e.g., storage 104 and memory 106 may be combined). In some embodiments, electronic device 100 can include other components not combined or included in those shown in FIG. 1 (e.g., motion detection components, a power supply such as a battery or kinetics, a display, bus, camera, or input mechanism, etc.), or several instances of the components shown in FIG. 1. For the sake of simplicity, only one of each of the components is shown in FIG. 1.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface of device 100.

Storage 104 can include, for example, one or more storage mediums including a hard-drive, solid state drive, flash memory, permanent memory such as read-only memory (“ROM”), any other suitable type of storage component, or any combination thereof. Storage 104 can store, for example, media data (e.g., music and video files), application data (e.g., for implementing functions on electronic device 100), firmware, authentication information (e.g., libraries of data associated with authorized users), user profile and lifestyle data (e.g., user preferences, age, and gender), transaction information data (e.g., information such as credit card information), wireless connection information data, contact information data (e.g., telephone numbers and email addresses), calendar information data, fashion items data (e.g., data related to a fashion item's color, style, material, date of purchase, or any other suitable fashion item data) and any other suitable data or any combination thereof.

Memory 106 can include cache memory, semi-permanent memory such as random-access memory (“RAM”), or any other suitable type of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

Input/output (“I/O”) circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen or button), physical movements (e.g., from a mouse or sensor), analog audio signals (e.g., from a microphone), visual signals (e.g., from a camera), or any other input. The digital data can be provided to and received from control circuitry 102, storage 104, memory 106, or any other component of electronic device 100.

Electronic device 100 can include any suitable interface or component for allowing a user to provide inputs to I/O circuitry 108. For example, electronic device 100 can include any suitable input mechanism, such as for example, a button, keypad, dial, click wheel, switch, touch screen, or any combination of the above. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to device 100 with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronic device 100. As another example, the display circuitry can include a movable display or a projecting system for providing a display of content on a surface remote from electronic device 100 (e.g., a video projector). In some embodiments, the display circuitry can include a coder/decoder (“CODEC”) to convert digital media data into analog signals. For example, the display circuitry (or other appropriate circuitry within electronic device 100) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and transmit or receive communications (e.g., voice, data, or both) to and/or from electronic device 100. For example, in some embodiments, communications circuitry 110 can be utilized to couple electronic device 100 to an external database of information, to a server, to another electronic device, or any combination of the above. Electronic device 100 can be coupled to the communications network through a physical coupling (e.g., through a cable), through wireless coupling, or both. As another example, communications circuitry 110 can be operative to interface with a communications network using any suitable communications protocol such as, for example, Wi-Fi (e.g., a 802.11 protocol), Bluetooth®, near field communications (“NFC”), radio frequency systems (e.g., 900 MHz, 2.4 GHz, and 5.6 GHz communication systems), infrared, GSM, GSM plus EDGE, CDMA, quadband, other cellular protocols, VOIP, or any other suitable protocol.

In some embodiments, electronic device 100 can be coupled to a host device. For example, electronic device 100 may be coupled to a host device for transferring data, syncing the electronic devices, updating software or firmware, providing performance information to a remote source, or performing any other suitable operation that can require electronic device 100 to be coupled to a host device.

Electronic device 100 can include any suitable type of electronic device. For example, electronic device 100 can include a portable electronic device that the user may hold in his or her hand, such as a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer.

An electronic device, such as electronic device 100 of FIG. 1, can provide a Virtual Closet. For example, the electronic device may run a software application that can be utilized to create, maintain, edit, update, or otherwise suitably interact with the Virtual Closet. A person may use this Virtual Closet, for example, to build a catalogue or virtual representation of an actual, physical closet which that person owns. For example, the Virtual Closet may include images, descriptions, or both of “fashion items” owned by the user. As used herein, the term “fashion item” refers to any article of clothing (e.g., pants, shirts, skirts, socks, dresses, jackets, or any other article of clothing), accessories (e.g., jewelry, hats, glasses, purses, or any other accessory), or any other suitable item that a person may wear or carry. As used herein, the term “outfit” refers to a combination of two or more such fashion items.

The Virtual Closet may include a catalogue of fashion items owned by a user. Each fashion item may be associated with metadata that defines the attributes of that fashion item. For example, the metadata may define attributes such as the fashion item's color, type (e.g., skirt, long-sleeved shirt, necklace, or any other suitable type description), material (e.g., silk), brand, style (e.g., formal, casual, or other suitable style), fit (e.g., loose clothing, tight clothing, or any other suitable fit), season (e.g., winter clothing), weather (e.g., appropriate for rainy weather), date of purchase, laundry status (e.g., whether the clothing is in the laundry and thus may be unavailable for being worn), or any other suitable attributes. The catalogue of fashions items (e.g., and any associated metadata or other data) can be stored in a suitable storage device such as, for example, storage 104 of FIG. 1. Alternatively or additionally, the catalogue can be stored in a remote server or database that can be accessed through, for example, communication circuitry 110 of FIG. 1.

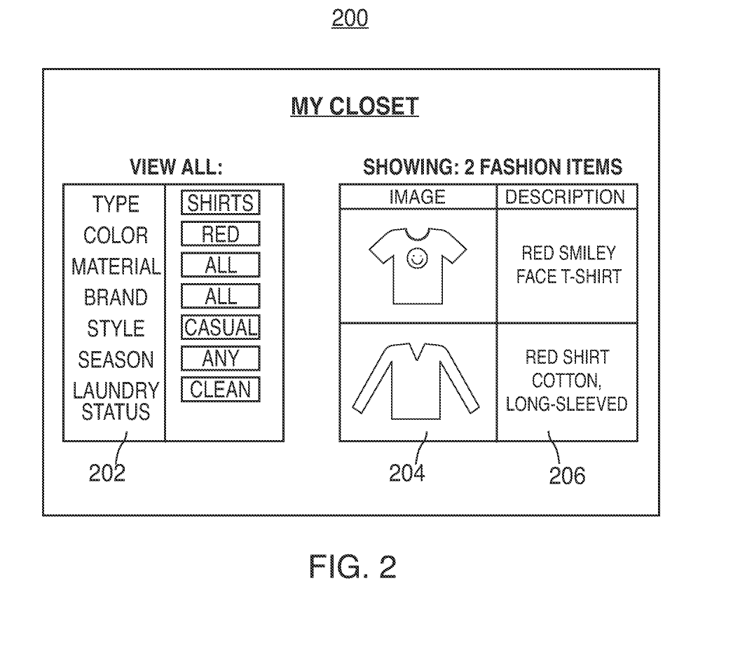

The Virtual Closet can sort and display the user's fashion items. For example, as illustrated by interface 200 of FIG. 2, the fashion items can be sorted and displayed through attributes 202. Attributes 202 can include any suitable attribute of a fashion item such as, for example, color, type, material, brand, style, fit, season, weather, date of purchase, laundry status, or any other suitable attribute. In some embodiments, certain attributes can be chosen, and fashion items matching these attributes can be displayed. For example, as illustrated in FIG. 2, the “type” is chosen to be “shirts,” the “color” is chosen to be “red,” the “material” is chosen to be “all” (e.g., all possible types of material), and so forth. The fashion items in the Virtual Closet that match the chosen attributes can be displayed in window 204. Interface 200 can also include description 206 of each fashion item displayed in window 204. Although the fashion items are displayed in a grid-type pattern in window 204, one skilled in the art could appreciate that the fashion items could alternatively be displayed in any suitable manner. For example, the fashion items may be displayed in a manner which mimics a real closet by depicting the clothing as hanging from hangers on a rod, depicting the jewelry as lying in a jewelry case, or otherwise suitably mimics a physical closet.

Utilizing the Virtual Closet can beneficially aid a user in organizing their clothing. For example, in a real, physical closet, the fashion items may be crowded together in a way that makes it difficult to view them, or the fashion items may be stored in drawers or otherwise hidden from sight. However, as the Virtual Closet may have no physical limit to the space or layout of the closet, the fashion items can be spread out in a readily viewable manner. Moreover, as illustrated in FIG. 2, the user can easily catalogue and view the fashion items. This may allow a user to easily view their entire collection of fashion items. This, in turn, may provide a user with an efficient way of identifying fashion items of which they own too much (“I own far too many pairs of jeans . . . ”), fashion items which they are lacking (“I don't own any work pants”), combinations of fashion items that create outfits, or otherwise organize and catalogue their fashion items.

In some embodiments, the Virtual Closet can indicate how many people (e.g., in the world, in a particular city, or in any other suitable location) are wearing a particular fashion item, own a particular fashion item, or both. In this manner, a user can easily identify which fashion items they own are currently popular items. A user may utilize this information, for example, to choose fashion items to wear that are currently popular or to avoid wearing fashion items that have a higher likelihood of being worn by other people at the same time.

Fashion items and their images can be added to a user's Virtual Closet in any suitable manner. For example, a user may take pictures of the fashion items within their closet, and upload these pictures to the Virtual Closet system. As another example, images of the fashion items may be downloaded to the Virtual Closet system via a server (e.g., downloaded from a website hosted by a third party).

Similarly, the attributes for the fashion items can be added to the Virtual Closet through any suitable manner. As one example, a user can manually enter the attributes of each fashion item (e.g., via I/O circuitry 108 of FIG. 1). As another example, each fashion item may include a barcode or other identifying tag that includes data associated with the attributes of the fashion item. The Virtual Closet system may then scan and read this data. As another example, the Virtual Closet system can automatically determine attributes by analyzing images of the fashion items. For example, the Virtual Closet system can perform image processing on the image of a fashion item to determine the item's color, style, material, or any other suitable attribute. As yet another example, if the image for a fashion item is downloaded via a server, the attributes may be concurrently downloaded from the server at that time. As yet another example, when a user purchases a new fashion item, the fashion item's metadata and any other suitable information (e.g., an image of the fashion item) can be communicated to and received by the Virtual Closet system (e.g., through communication circuitry 110 of FIG. 1). In this manner, a user's Virtual Closet can be automatically updated and maintained whenever the user purchases new items.

In some embodiments, the Virtual Closet system can provide recommendations of outfits. Generally, an outfit can be created such that the color, style, or other attributes of the fashion items in the outfit are complementary to one another, or otherwise produce an outfit that is pleasing to view. For example, the Virtual Closet system may run an algorithm that selects different combinations of fashion items. A particular combination of fashion items can then be saved, provided to the user, or both when that combination produces a suitable outfit.

In some embodiments, the Virtual Closet system can provide outfit recommendations based on a particular events. For example, the Virtual Closet system can be coupled to a weather server (e.g., through communication circuitry 110) and can receive weather information. The outfit recommendations may then be provided based on the weather information (e.g., a rain jacket and galoshes can be recommended on a rainy day). As another example, the Virtual Closet system may be coupled to a calendar and can provide recommendations based on the season or date (e.g., a heavy sweater and wool hat can be recommended in January). As another example, the Virtual Closet system may be coupled to the user's personal calendar, and may provide recommendations based on the user's daily activities (e.g., a suit can be recommended when a business meeting is scheduled, or hiking boots and shorts can be recommended when a camping trip is scheduled). When the user's calendar indicates that the user is going on a trip, the Virtual Closet can “pack the user's suitcase” by recommending a suitable collection of outfits to be taken on that trip.

In some embodiments, vendors or other fashion item providers may have access to a user's Virtual Closet. The vendor can analyze the user's collection of fashion items, and provide recommendations for fashion items to be purchased. For example, a vendor may recommend a particular fashion item that could be combined with the user's current clothing to complete an outfit. In some embodiments, the vendor can send a notice to the user through the Virtual Closet system of a new fashion item that is now available for purchase. The notice may include images of various outfits that can be created by combining the new fashion item with the user's current fashion items. The notice may also include, for example, a link to the vendor's website, a link for purchasing the fashion item, an option that allows the user to build their own outfits with the new fashion (e.g., thereby giving them the opportunity to “try out” the new fashion item and decide whether or not they want to purchase it), or any other suitable option.

In some embodiments, a fashion consultant can have access to the Virtual Closet. For example, the fashion consultant may be hired by the user. The fashion consultant may then, for example, provide recommendations to buy certain fashion items, provide recommendations to get rid of certain fashion items, build outfits, suggest outfits for certain occasions (e.g., for an upcoming party), or in any other suitable manner provide fashion advice to the user. The fashion consultant may be hired on a periodic basis (e.g., he is paid on a monthly or yearly basis), hired on a one-time basis (e.g., hired to provide an outfit recommendation for a particular occasion), or hired for any other suitable length of time.

In addition to viewing a particular outfit (e.g., an outfit created with the user's fashion items or an outfit created with a combination of the user's fashion items and fashion items that are offered for sale by a vendor), a user may dress a virtual avatar with an outfit. For example, the Virtual Closet system may generate an avatar that substantially matches the user in build, height, skin tone, or in any other suitable manner matches the user. Fashion items can be overlaid onto the avatar in order to “dress” the avatar, thus allowing the user to substantially represent how the fashion items would appear on the user. In this manner, a user can view a representation of how a fashion item would appear on them, even when the user does not physically possess the fashion item and thus cannot physically try it on (e.g., such as when a user receives a notice from a vendor offering a fashion item for sale). Systems and methods for providing such an avatar are described in more detail in the Patent Application entitled, “Personal Shopping Avatar,” patent application Ser. No. ______ and attorney docket number P7363US1, filed on ______, which is hereby incorporated by reference in its entirety.

In some embodiments, the Virtual Closet system can maintain a history of the fashion items, outfits, or both that are worn by a user. The Virtual Closet system can determine when a user wears a fashion item by, for example, taking a picture of the user when they leave their room, sensing when a fashion item is removed from the physical closet (e.g., via an optical sensor, via a motion sensor, via a sensor that can read an identifying tag on the fashion item, or via any other suitable sensor), receiving an input from the user indicating they wore the fashion item, or in any other suitable manner can determine when a user wears a fashion item. The history can provide a user with, for example, a record of when they wore a particular fashion item, how often they wear a particular fashion item, or both.

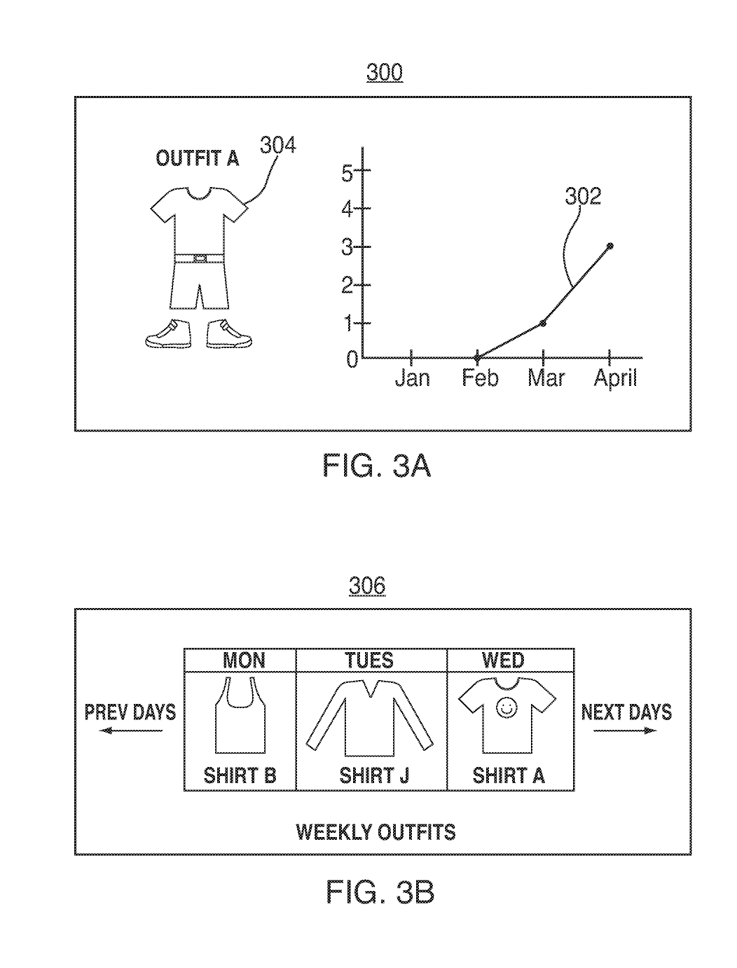

Moreover, in some embodiments a graphical representation of the history can be generated. For example, FIG. 3A shows interface 300 that can include graph 302 indicating how many times a month outfit 304 is worn. In some embodiments, graph 302 can indicate how often a single fashion item (e.g., rather than an outfit) is worn. As another example, FIG. 3B shows interface 306 that can indicate what fashion item or items were worn on each calendar day. In some embodiments, the graph can be generated based on any suitable attributes of the fashion items (e.g., color, type, style, brand, material, season, fit, laundry status, date of purchase, or any other suitable attribute). For example, a graph can be generated that shows how often blue-colored fashion items were worn in the past month.

In some embodiments, outfit recommendations can be provided to a user based on their history and calendar events. For example, by comparing the calendar and the history, the Virtual Closet system may determine that the user wore Outfit XYZ the last time the user was scheduled to meet a certain person. The next time the user is scheduled to meet this same person, the Virtual Closet system may recommend an outfit to wear other than Outfit XYZ. Alternatively, the Virtual Closet system may recommend an outfit other than Outfit XYZ the next several times the user meets this person. In this manner, the user can be warned against wearing the same outfit twice in a row or too often when meeting the same person.

In some embodiments, the Virtual Closet system can keep track of what fashion items are dirty or are in the laundry (e.g., and thus may be unavailable for wearing). The outfit recommendations can then be generated by only creating outfits that include fashion items that are currently clean. The Virtual Closet system can determine what fashion items are dirty by, for example, taking a picture of the user when they leave the room, sensing fashion items that are removed from the physical closet, receiving an input from the user indicating which fashion items are in the laundry, or through any other suitable manner.

In some embodiments, the Virtual Closet can include an interface that displays a “virtual hamper” that includes fashion items that are currently dirty. A user may, for example, select an input that “empties” the virtual hamper whenever they do their laundry, thus indicating to the Virtual Closet system that the fashion items in the virtual hamper are now clean. In response to receiving such an input, the Virtual Closet system may update the interface to display the virtual hamper as being empty. In some embodiments, the Virtual Closet system can receive an input indicating that only a portion of the dirty laundry was cleaned (e.g., dry cleaning was completed). The Virtual Closet system may then remove the appropriate set of clothing from the virtual hamper (e.g., by removing all “dry clean only” clothing).

In some embodiments, a particular fashion item may be currently dirty but is required to be worn on a particular day or on at a particular event (e.g., a black suit coat is needed for a business meeting on Tuesday). The Virtual Closet system may then provide the user with an appropriate notification that the laundry must be done or that this particular fashion item must be cleaned. For example, the Virtual Closet system can provide a display with a pop-up notification that warns, “Your black suit must be cleaned in time for the business meeting with Mr. Smith on Tuesday!”

In some embodiments, the Virtual Closet can be shared with friends and acquaintances. As used herein, the term “friend” refers to a person, other than the owner of the Virtual Closet, with whom the owner has shared or otherwise granted access to their Virtual Closet. Generally, an owner may have a personal relationship with the friend (e.g., the friend is not a vendor or a store). By accessing the owner's Virtual Closet, a friend may be able to, for example, view the owner's fashion items, view the owner's outfits, provide feedback on the owner's fashion items, or otherwise suitably interact with the owner's Virtual Closet. In this manner, the Virtual Closet may provide a social networking environment that can allow people to connect and communicate with one another, and can facilitate the sharing of thoughts and opinions regarding an owner's fashion items.

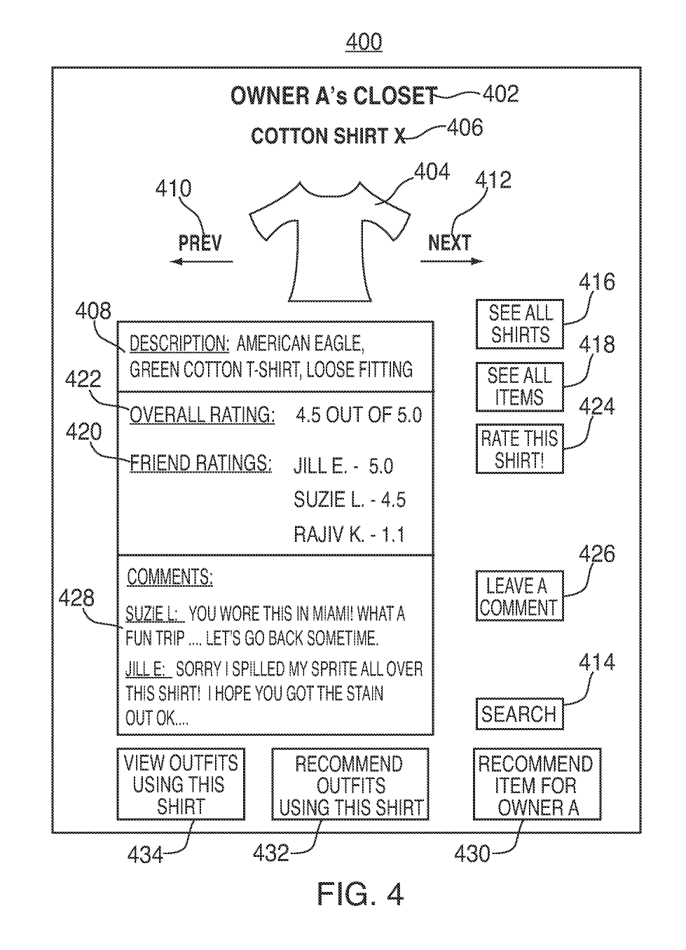

FIG. 4 shows interface 400 that can provide a social networking Virtual Closet in accordance with an exemplary embodiment. Interface 400 may have title 402 that can indicate the owner of the social networking Virtual Closet (e.g., “Owner A”). Interface 400 can display a particular fashion item or outfit such as, for example, fashion item 404. The name of fashion item 404 can be indicated by nametag 406 (e.g., “Cotton Shirt X”). Description 408 can include any suitable description of fashion item 404. Interface 400 can include selectable links or other suitable inputs to allow one to view other fashion items within the Virtual Closet such as, for example, previous link 410, next link 412, or any other suitable input. Previous link 410 can be used to generate an interface displaying the previous fashion item or outfit within the Virtual Closet. Similarly, next link 412 can be used to generate an interface displaying the next fashion item or outfit with the Virtual Closet.

Fashion items, outfits, or both within the social networking Virtual Closet can be searched for by choosing Search Input 414. As one example, a friend can search the fashion items by choosing any suitable attributes of the fashion items such as color, type, material, brand, style, fit, season, weather, date of purchase, laundry status, or any other suitable attribute. As an illustration, to generate interface 400, a search may have been run that identifies fashion items in which the “type” of fashion item is a “shirt.” Interface 400 may then include See All Shirts Input 416 that can generate an interface that displays all fashion items matching this search (e.g., that displays all shirts in the owner's Virtual Closet). In this case, previous input 410 and next input 412 may be used to display, respectively, the previous and next fashion items matching the search. See All Items Input 418 can generate an interface that displays the entire collection of fashion items in the owner's Virtual Closet.

In some embodiments, friends can provide ratings of the fashion items in the owner's Virtual Closet. For example, friend ratings 420 can depict the ratings that one or more friends have given to fashion item 404. For example, as illustrated in FIG. 4, Jill E. has rated fashion item 404 as a 5.0/5.0, Suzie L. has rated fashion item 404 as 4.5/5.0, and Rajiv K. has rated fashion item 404 as 1.1/5.0. Overall rating 422 can include, for example, an average of the ratings that have been provided for fashion item 404. Rate Input 424 can be utilized to allow a friend to enter a rating for fashion item 404.

Comment Input 426 can allow a friend to leave a comment on an owner's fashion item. As an illustration, the comment can include the friend's opinion of the fashion item, a memory the friend has that involves the fashion item, or any other type of comment. The comments which friends have entered for a fashion item can be displayed in, for example, Comment Box 428. An owner can have the option to control Comment Box 428. For example, an owner can delete comments from Comment Box 428, choose not display certain comments, or otherwise suitably control Comment Box 428.

In some embodiments, a friend can recommend a fashion item to the owner of the social networking Virtual Closet. For example, a friend can recommend an item which they feel the owner is lacking in their Virtual Closet (e.g., you should buy a jean vest). As another example, a friend may recommend an item that can be used to complete a particular outfit. The recommended item can include, for example, a fashion item from the friend's own Virtual Closet (e.g., a link to or an image of a fashion item from the friend's Virtual Closet), an item that is for sale on a vendor's webpage, a description of a general fashion item (e.g., “you should get some shirts that are colorful”), or any other suitable fashion item. Recommend Item Input 430 can be selected to enter a fashion item recommendation. In some embodiments, a friend can provide a recommendation for the owner to get rid of a particular fashion item.

In some embodiments, a friend can build outfits with fashion item 404 through Recommend Outfits Input 432. For example, the friend can build an outfit that includes fashions items from the owner's Virtual Closet, fashion items from the friend's Virtual Closet, fashion items accessed through a server (e.g., from a vendor's website), any other suitable fashion item, or any combination of the above. The owner may then view the recommended outfit that was built by the friend. In this manner, friends can share outfits and fashion items with one another, provide feedback on each other's outfits and fashion items, and otherwise share opinions and ideas regarding their Virtual Closets. As another illustration, a friend may use an owner's Virtual Closet to identify suitable gifts for the owner. For example, a friend may view an owner's Virtual Closet, notice the owner is missing a particular fashion item, find this particular fashion item on a vendor's website, try building various outfits that include the particular fashion, and determine whether or not to buy the particular fashion item as a gift by judging the outfits they have built.

In some embodiments, friends may also have access to an owner's calendar. In this case, a friend can provide an outfit or fashion item recommendation based on a particular event. For example, a friend may notice that the owner is going to a concert on a particular date. The friend may then build an outfit and provide a recommendation to the owner to wear that outfit to the concert. This may, for example, provide a convenient way for a group of friends to coordinate their clothing. For example, a group of friends may desire to wear the same team t-shirt to a sports game, and may coordinate this effort through the social networking Virtual Closet. As another example, friends may want to coordinate their outfits such that two friends do not wearing the same outfit to the same event (e.g., so two friends do not wear the same dress to the same party).

In some embodiments, an owner can send out a notice to one or more friends requesting outfit recommendations through the social networking Virtual Closet. For example, an owner may be going to a special event on a particular date, but has not decided what clothing to wear. The owner may then send a notice to their friends requesting outfit recommendations for this special event. Friends may then respond to this notice by building outfits for the owner to view. As another example, an owner may have bought a new fashion item, but does not know what outfits can be built from this fashion item. In this scenario, the owner may send a notice to their friends requesting recommendations for outfits that include the new fashion item.

The social networking Virtual Closet can allow an owner to have control over how friends interact with the owner's Virtual Closet. For example, an owner may have control over who is granted access to the Virtual Closet. In this case, it may be necessary for an owner to “invite” a friend before that friend is granted access to the owner's Virtual Closet. As another example, an owner may be able to grant a friend limited access to the owner's Virtual Closet. In this case, the owner may have the option to restrict the friend's ability to leave ratings, restrict the friend's ability to leave comments, restrict the friend's ability to view certain fashion items, or may otherwise suitably limit the friend's access to the owner's Virtual Closet. As another example, the social networking Virtual Closet may allow an owner to block a particular friend, such that this friend cannot access or locate the owner's Virtual Closet.

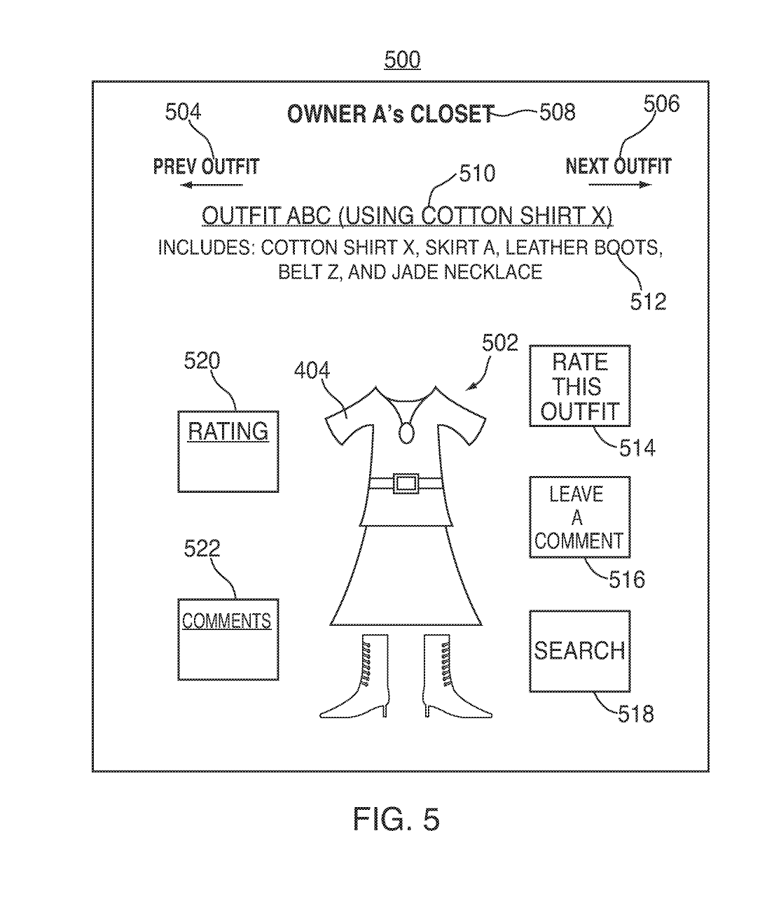

To view outfits including a fashion item in an owner's Virtual Closet, an input such as View Outfits Input 434 can be selected. As an exemplary illustration, View Outfits Input 434 can be used to generate interface 500 of FIG. 5 that displays outfit 502 including fashion item 404. Outfit 502 can include, for example, an outfit that was created by the owner, and outfit that was created by a friend, an outfit that was created by the Virtual Closet system, and outfit that was created by a vendor, any other suitable outfit, or any combination of the above. Although interface 500 is illustrated as displaying a single outfit at one time, one skilled in the art could appreciate that interface 500 may alternatively display two or more outfits at a time (e.g., interface 500 may display all outfits that can be created from a particular fashion item at once). Previous input 504 and next input 506 can be used to display, respectively, the previous or next outfits including fashion item 404.

Interface 500 can include title 508 that indicates the owner of the social networking Virtual Closet (e.g., “Owner A”). The name of outfit 502 can be displayed by nametag 510. Description 512 can include any suitable description of outfit 502. For example, description 512 can include a listing of the fashion items that are used to build outfit 502. In some embodiments, each fashion item listed in description 512 can be a selectable link that, when selected, generates a display describing the selected fashion item such. For example, an interface such as interface 400 of FIG. 4 can be generated when a fashion item of description 512 is selected.

Similar to interface 400 of FIG. 4, interface 500 can include Rate Outfit Input 514, Comment Input 516, and Search Input 518. Rate Outfit Input 514 can allow ratings for outfit 502 to be entered. Ratings that have been entered, an overall rating, or both, can be displayed in Rating Box 520. Comment Input 516 can allow comments for outfit 502 to be entered, which may then be displayed in Comment Box 522. Similar to Comment Box 428 of FIG. 4, an owner can have the option to control Comment Box 522 by, for example, deleting comments, hiding comments, or otherwise suitably controlling Comment Box 522. Search Input 518 can allow searches for fashion items, outfits, or both to be performed.

Oftentimes, an owner may want to share their clothing, jewelry, or other fashion items with friends and acquaintances, and allow these people to borrow the fashion items. However, the friends may not readily know what items are available for borrowing or at what times they can be borrowed (e.g., a friend likely could not borrow a particular shirt when the owner herself is planning to wear that shirt). Furthermore, after an owner lets a friend borrow a fashion item, the owner may forget who borrowed that fashion item and thus may accidentally lose track of it. Also, at times a group of friends may purchase a single fashion item together. For example, a group of friends may decide to purchase a single pair of boots together when each friend individually could not afford to buy those boots. In this scenario, the group of friends may not readily know when it is their turn to wear the boots, who currently has possession of the boots, or when the boots are free to be borrowed.

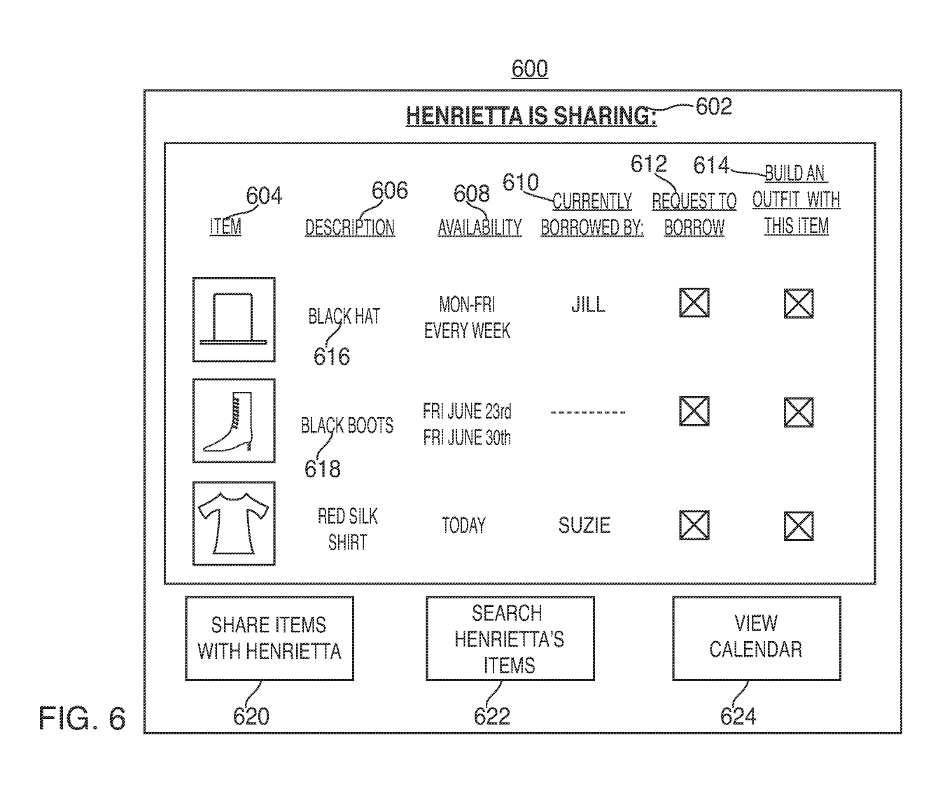

FIG. 6 shows interface 600 that can provide for the borrowing and sharing fashion items of a Virtual Closet. Title 602 can indicate the owner who is allowing their fashion items to be borrowed (e.g., “Henrietta”). The fashion items that the owner is sharing can be depicted in Item Column 604. For example, Item Column 604 can include images of the fashion items that are available for borrowing. Description Column 606 can include any suitable description of the fashion items in Item Column 604.

Availability Column 608 can indicate when a friend can borrow a particular fashion item. For example, availability Column 608 can indicate a time period such as a recurring time period (e.g., “Monday-Friday, every week”), a one-instance time period (e.g., “Friday, June 23^{rd}”), a current date (e.g., “today”), or any other suitable time period.

Currently Borrowed Column 610 can indicate who is currently borrowing a fashion item from the owner's Virtual Closet. This may, for example, aid an owner in keeping track of where their fashion items are located. As another example, Currently Borrowed Column 610 can aid a friend in determining to whom they should go to pick up a fashion item they want to borrow. For example, if a friend desires to borrow Black Hat 616, Currently Borrowed Column 610 indicates that the friend should retrieve this fashion item from Jill. As another example, if a friend desires to borrow Black Boots 618, Currently Borrowed Column 610 indicates that no one is currently borrowing this item. In this case, the friend can retrieve Black Boots 618 from the owner of the Virtual Closet.

Request Column 612 can allow a request to borrow a particular fashion item to be entered. Build Outfit Column 614 can allow one to build outfits from the fashion items that are available for borrowing. To make fashion items available for one or more friends to borrow, Share Input 620 can be utilized. For example, Share Input 620 can be utilized to allow the owner to share a fashion item with friends, to allow friends to share a fashion item with the owner, or in any other suitable manner allow a person to share a fashion item with another person. Search Input 518 can allow searches for fashion items, outfits, or both that are available for borrowing to be performed.

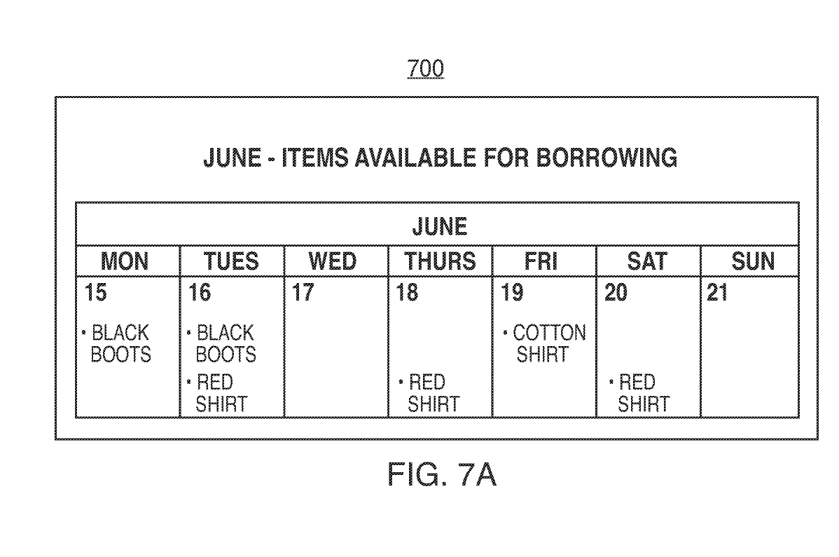

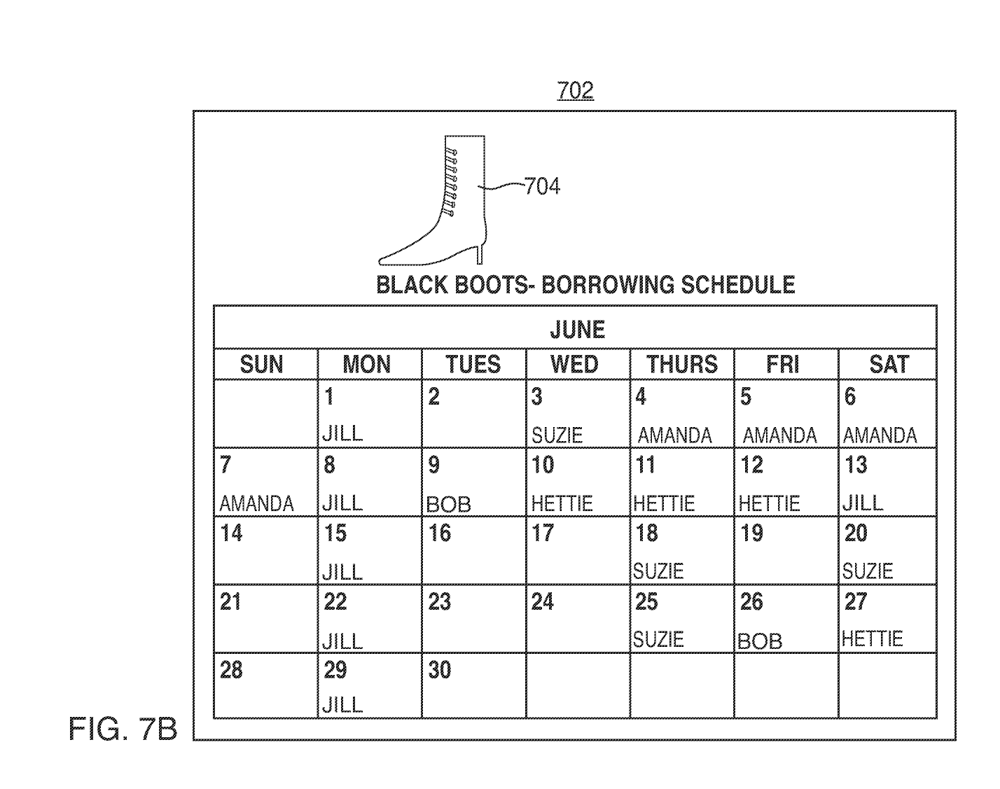

View Calendar Input 624 can generate a calendar view of fashion items that are available for borrowing. For example, as illustrated by FIG. 7A, calendar 700 can include a listing of each day and what fashion items are available to be borrowed on that day. As another example, the calendar can include a listing of each day and who is scheduled to borrow a particular fashion item on this day. As illustrated in FIG. 7B, calendar 702 can indicate which friend is schedule to borrow fashion item 704 on which day. This may, for example, aid a group of friends who have purchased a single fashion item together to effectively share this fashion item with one another.

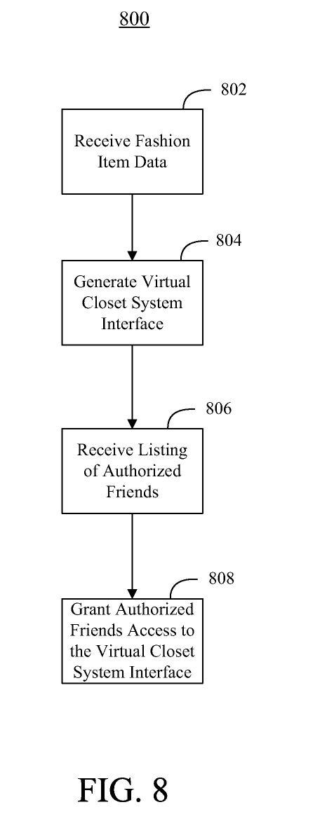

FIG. 8 shows process 800 for providing a social networking Virtual Closet. At step 802, data related to one or more fashion items can be received. For example, images of the fashion items, attributes of the fashion items, descriptions of the fashion items, or any other suitable information can be received.

At step 804, a Virtual Closet system interface can be generated. For example, interfaces such as those illustrated by FIGS. 2-7B or any other suitable interface can be generated.

At step 806, a listing of authorized friends can be received. As one example, an input can be received from the owner of the Virtual Closet system indicating which people are authorized friends. As another example, rather than receiving a listing of authorized friends, a listing of blocked friends can be received. In this case, any person who is not indicated on the listing of blocked friends can be included as an authorized friend. As yet another example, the Virtual Closet system may be open to the public. In this case, any person in the social network could be included as an authorized friend.

At step 808, authorized friends can be granted access to the Virtual Closet system interface. For example, the authorized friends can be granted access to view the fashion items in the Virtual Closet system, view outfits, rate fashion items and outfits, leave comments on fashion items and outfits, recommend fashion items and outfits, search the Virtual Closet system, share and borrow fashion items and outfits, or any combination of the above. In some embodiments, limited access can be granted to one or more authorized friends.

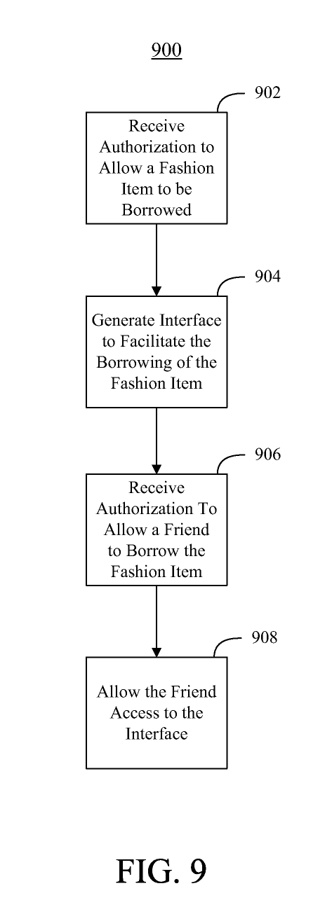

FIG. 9 shows process 900 for facilitating the borrowing of a fashion item of a social networking Virtual Closet. At step 902, authorization to allow a particular fashion item to be borrowed can be received. For example, the Virtual Closet system can receive an input from the owner of the Virtual Closet indicating the fashion item can be borrowed.

At step 904, an interface for facilitating the borrowing of the fashion item can be generated. For example, an interface such as interface 600 of FIG. 6, interface 700 of FIG. 7A, or interface 702 of FIG. 7B, or any other suitable interface can be generated.

At step 706, authorization to allow a friend to borrow the fashion item identified at step 902 can be received. For example, the Virtual Closet system can receive an input from the owner of the Virtual Closet indicating that the friend can borrow the fashion item. At step 708, the friend can be granted access to the interface generated at step 904.

The process discussed above is intended to be illustrative and not limiting. Persons skilled in the art could appreciate that steps of the process discussed herein can be omitted, modified, combined, or rearranged, and any additional steps can be performed without departing from the scope of the invention.

In addition, it will be apparent to those of ordinary skill in the art that methods involved in the invention may be embodied in a computer program product that includes a machine readable and/or usable medium. For example, such a computer usable medium may consist of a read-only memory device, such as a CD ROM disk or conventional ROM device, or a random access memory, such as a hard drive device or a computer diskette, or flash memory device having a computer readable program code stored thereon.

Although the preceding discussion was described in terms of fashion items, it will be understood that the principles of the embodiments described above can be applied to any suitable object. For example, a Virtual Closet can be created that includes furniture, collectibles (e.g., sports cards), refrigerator or other grocery items, toiletry items, store itineraries, or any other suitable item.

The above-described embodiments of the invention are presented for purposes of illustration and not of limitation, and the invention is limited only by the claims which follow.

What is claimed is:

1. A system comprising:
a storage device operable to store a listing of fashion items owned by a user, wherein the listing comprises at least one of an attribute of and an image of each fashion item of the listing;
communication circuitry operable to receive a request to access the listing; and
a processor operable to:
determine the request is received from an authorized friend of the user; and
grant the authorized friend access to the listing in response to determining.

2. The system of 1, wherein the processor is further operable to:
generate an interface comprising the listing and at least one of an option to comment on fashion items of the listing and an option to leave ratings on fashion items of the listing, wherein the generated interface is accessible via the internet; and
grant the authorized friend access to the generated interface.

3. The system of claim 2, wherein the on-line interface further comprises an option allowing the authorized friend to build a recommended outfit, wherein the recommended outfit comprises at least one fashion item of the listing.

4. The system of claim 3, wherein the recommended outfit further comprises at least one fashion item of a listing of fashion items owned by the authorized friend.

5. The system of claim 3, wherein the recommended outfit further comprises at least one fashion item offered for sale by a third party vendor.

6. The system of claim 2, wherein the on-line interface further comprises:
a calendar listing at least one event the user is scheduled to attend; and
an option allowing the authorized friend to recommend a particular outfit for the user to wear at the at least one event.

7. The system of 1, wherein the processor is further operable to:
determine the user is scheduled to wear a particular outfit on a particular date;
determine the particular outfit is currently in the laundry; and
provide a notification to the user indicating the particular outfit should be cleaned.

8. The system of 1, wherein the processor is further operable to:
receive a search request comprising at least one search attribute;
identify at least one fashion item of the listing comprising an attribute matching the search attribute; and
provide the identified at least one fashion item in response to the identifying.

9. A method of providing a social networking Virtual Closet, the method comprising:
identifying fashion item data associated with at least one fashion item owned by a user;
generating a Virtual Closet interface comprising the fashion item data;
identifying a friend of the user;
determining the friend is authorized to access the Virtual Closet interface; and
providing the friend access to the Virtual Closet interface in response to the determining.

10. The method of claim 9, wherein providing the friend access comprises providing an option in the Virtual Closet interface for rating the at least one fashion item.

11. The method of claim 9, wherein providing the friend access comprises providing an option in the Virtual Closet interface for leaving a comment about the at least one fashion item.

12. The method of claim 9, wherein identifying fashion item data comprises at least one of analyzing an image of the at least one fashion item, scanning an identifying tag of the at least on fashion item, and downloading the fashion item data from a remote server.

13. The method of claim 1, wherein the fashion item data comprises historical data associated with the usage of the at least one fashion item.

14. The method of claim 1, wherein the fashion item data comprises at least one of an image of each fashion item of the at least one fashion item, a description of each fashion item, and at least one attribute of each fashion item.

15. The method of claim 14, wherein the at least one attribute comprises at least one of a fashion item color, type, material, brand, style, fit, season, weather, date of purchase, and laundry status.

16. The method of claim 9, wherein determining the friend is authorized comprises determining the friend has limited access to the Virtual Closet interface.

17. A method comprising:
identifying at least one fashion item that is authorized to be borrowed, wherein the at least one fashion item is owned by a owner;
generating an interface to facilitate a borrowing of the at least one fashion item;
identifying at least one friend of the owner who is authorized to borrow the at least one fashion item; and
providing the at least one friend access to the interface.

18. The method of claim 17, wherein the interface comprises a display indicating when the at least one fashion item is available to be borrowed.

19. The method of claim 17, wherein the interface comprises a display indicating a person scheduled to borrow the at least one fashion item.

20. The method of claim 17, wherein the interface comprises an option to request to borrow the at least one fashion item.

21. The method of claim 17, wherein the interface comprises at least one of a description of the at least one fashion item, an option to build an outfit comprising the at least one fashion item, and a name of the owner.

22. The method of claim 17, wherein the interface comprises an option allowing the at least one friend to share a fashion item of the at least one friend with the owner for borrowing.

23. Machine-readable media comprising machine-readable instructions recorded thereon for:
identifying at least one fashion item that is authorized to be borrowed, wherein the at least one fashion item is owned by a owner;
generating an interface to facilitate a borrowing of the at least one fashion item;
identifying at least one friend of the owner who is authorized to borrow the at least one fashion item; and
providing the at least one friend access to the interface.
